(19) United States
(12) Patent Application Publication
(10) Pub. No.: US 2026/0363451 A1
(43) Pub. Date: Nov. 19, 2026

(54) Cushion Systems with Contoured Support

(71) Applicant: Kalogon, Inc., Melbourne, FL (US)

(72) Inventors: William Davignon, Melbourne, FL (US); Kaitlyn Davignon, Greenwood, IN (US); Timothy Balz, Melbourne, FL (US); Aaron Jones, Melbourne, FL (US); Christian Balcom, Melbourne, FL (US); Evan Rosenberg, Rockledge, FL (US)

(73) Assignee: Kalogon, Inc., Melbourne, FL (US)

(21) Appl. No.: 19/565,019

(22) Filed: Mar. 12, 2026

Related U.S. Application Data
(60) Provisional application No. 63/806,618, filed on May 15, 2025.

(51) Int. Cl. A47C 27/08

(52) U.S. Cl. CPC A47C 27/083; A47C 27/082

(57) ABSTRACT

Cushion systems and methods of providing cushion systems that include a support that has a top surface and a bottom surface, wherein the support includes a contoured portion such that the support has a first region having a first height and a second region having a second height, wherein the first height is different from the second height. A plurality of air bladders are positioned on the top surface of the support. A first air bladder of the plurality of air bladders is at least partially positioned on the contoured portion of the support.

### CROSS-REFERENCE TO RELATED APPLICATION

This application claims the benefit of priority of U.S. Provisional Application Ser. No. 63/806,618 filed on May 15, 2026 and entitled “Cushion Systems and Methods,” the content of which is relied upon and incorporated herein by reference in its entirety.

### TECHNICAL FIELD

Various aspects of the present disclosure relate generally to systems and methods for cushions and, more particularly, to systems and methods for adaptive cushions with adjustable air bladders for providing customized support and pressure distribution.

### BACKGROUND

Cushion systems have long been used to provide comfort and support for individuals in various seating applications. These systems can range from simple foam padding to more complex arrangements involving multiple layers and adjustable components. For example, some existing cushion systems utilize air bladders as a means of providing adjustable support. However, existing air bladder systems often lack the ability to precisely control pressure distribution across different areas of the cushion. This limitation can result in suboptimal support and potential discomfort for users, particularly during extended periods of sitting.

Existing cushion systems also lack the ability to be customized for specific users or to address particular support requirements. This limitation is particularly problematic in the healthcare sector, where patients have diverse needs that cannot be adequately addressed with one-size-fits-all solutions. Current cushions typically provide limited adjustability and fail to properly redistribute pressure for individuals with unique body shapes, sizes, or medical conditions. There is a significant need for cushion systems that can be tailored to meet specific patient requirements, which may contribute to reduced hospital stays and improved quality of life for patients with limited mobility. This need extends to users of wheelchairs and other mobility devices, where prolonged sitting without proper customized support can lead to various health issues including pressure injuries, postural problems, and discomfort. The market demands more personalized and adaptable cushion solutions that can be configured to address individual physical requirements and therapeutic objectives.

As cushion technology continues to evolve, there is a growing focus on personalization and adaptability. Users increasingly expect seating solutions that can learn from their preferences and automatically adjust to provide optimal comfort and support. This trend towards smarter, more responsive cushion systems opens up new possibilities for enhancing user experience across a wide range of seating applications.

The present disclosure is directed to overcoming one or more of these above-referenced challenges.

### SUMMARY OF THE DISCLOSURE

According to certain aspects of the disclosure, systems and methods are disclosed for adaptive cushions that provide customized support and pressure distribution.

According to an aspect of the present disclosure, a cushion system may be provided. The cushion system may comprise a support having a top surface and a bottom surface. The support may include a contoured portion such that the support has a first region having a first height and a second region having a second height, wherein the first height can be different from the second height. The cushion system may further comprise a plurality of air bladders positioned on the top surface of the support. A first air bladder of the plurality of air bladders may be at least partially positioned on the contoured portion of the support.

In certain examples of the present disclosure, the first air bladder may be configured to load tissue that supports the greater trochanter when the user is seated on the support. In some examples, the contoured portion may be a first contoured portion, and the support may include a second contoured portion, and a second air bladder of the plurality of air bladders may be at least partially positioned on the second contoured portion. The first air bladder may be configured to load tissue that supports a first trochanter of a user and the second air bladder may be configured to load tissue that supports a second trochanter of the user when the user is seated on the support. The cushion system may further comprise a third air bladder of the plurality of air bladders positioned on a central region located at least partially between the first and second contoured portions, wherein at least a portion of one of the plurality of air bladders can extend vertically higher than at least a portion of the third air bladder when inflated to a common pressure. In certain examples, the support may comprise a first lateral pelvic support region and a second lateral pelvic support region angled towards a central region of the support. The support may further comprise a pelvic ridge located between a front end and a rear end of the support. In some examples, at least one of the plurality of air bladders may have a non-uniform thickness across a cross-section of the at least one air bladder. The first height may be at least 0.5 inches greater than the second height. The cushion system may further comprise a battery for providing power to the cushion system. The cushion system may further comprise an air pump, wherein the air pump can be configured to provide at least one of sequential inflation or deflation of one or more of the plurality of air bladders, or a low interface pressure throughout at least a portion of the cushion system.

According to another aspect of the present disclosure, a method of providing a cushion system may be provided. The method may comprise providing a support having a top surface and a bottom surface. The support may include a contoured portion such that the support has a first region having a first height and a second region having a second height, wherein the first height can be different from the second height. The method may further comprise positioning a plurality of air bladders on or above the top surface of the support. A first air bladder of the plurality of air bladders may be at least partially positioned on the contoured portion of the support.

In certain examples of the present disclosure, the first air bladder may be configured to load tissue that supports the greater trochanter when the user is seated on the support. In some examples, the contoured portion may be a first contoured portion, and the support may include a second contoured portion, and a second air bladder of the plurality of air bladders may be at least partially positioned on the second contoured portion. The first air bladder may be configured to load tissue that supports a first trochanter of a user and the second air bladder may be configured to load tissue that supports a second trochanter of the user when the user is seated on the support. The method may further comprise positioning a third air bladder of the plurality of air bladders on a central region located at least partially between the first and second contoured portions, wherein at least a portion of one of the plurality of air bladders can extend vertically higher than at least a portion of the third air bladder when inflated to a common pressure. In certain examples, the support may comprise a first lateral pelvic support region and a second lateral pelvic support region angled towards a central region of the support. The support may further comprise a pelvic ridge located between a front end and a rear end of the support. In some examples, the method may further comprise using heat to form at least one of the plurality of air bladders to have a non-uniform thickness across a cross-section of the at least one air bladder.

According to another aspect of the present disclosure, a cushion system may be provided. The cushion system may comprise a support comprising a first contoured region, a second contoured region, and a central region located between the first and second contoured regions. A thickness of the support at the central region may be less than a thickness of the support at the first contoured region. The thickness of the support at the central region may be less than a thickness of the support at the second contoured region. The cushion system may further comprise a plurality of air bladders positioned above the support. A first air bladder of the plurality of air bladders may extend over the first contoured region and a second of the plurality of air bladders may extend over the second contoured region.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 depicts a cushion system, according to aspects of the present disclosure.

FIG. 2 depicts a cushion system, according to aspects of the present disclosure.

FIG. 3 depicts a cushion system, according to aspects of the present disclosure.

FIG. 4 depicts a cushion system, according to aspects of the present disclosure.

FIG. 5 depicts a bottom surface of a cushion support, according to aspects of the present disclosure.

FIG. 6 depicts a cover assembly for a cushion system, according to aspects of the present disclosure.

FIG. 7 depicts a cushion assembly, according to aspects of the present disclosure.

FIG. 8 depicts a cushion system, according to aspects of the present disclosure.

FIG. 9 depicts a support for a cushion system, according to aspects of the present disclosure.

FIG. 10 depicts an anatomical view of a user’s pelvic region.

FIG. 11 depicts a cushion system, according to aspects of the present disclosure.

FIG. 12 depicts an exemplary method for using a cushion system, according to aspects of the present disclosure.

FIG. 13 depicts an exemplary method for using a cushion system, according to aspects of the present disclosure.

FIG. 14 depicts an exemplary method for manufacturing cushion system, according to aspects of the present disclosure.

FIG. 15 depicts an exemplary system that may execute techniques presented herein.

### DETAILED DESCRIPTION

The present disclosure generally relates to systems and methods for cushions and, more particularly, to systems and methods for adaptive cushions that utilize adjustable air bladders to provide customized support and pressure distribution for users. These systems may incorporate sensors, control mechanisms, and/or user interfaces to dynamically adjust cushion properties based on user characteristics, movements, and environmental factors. The systems may utilize bladders and supports having varying shapes and contours to provide targeted pressure distribution and anatomically-informed support across different regions of the cushion surface. The cushion systems described herein may be applicable to various seating applications, including but not limited to vehicle seats, office chairs, and medical support surfaces. By leveraging advanced technologies and innovative design approaches, these cushion systems aim to enhance user comfort, reduce fatigue, and accommodate a wide range of body types and seating scenarios.

### 1. Cushion system designs and methods

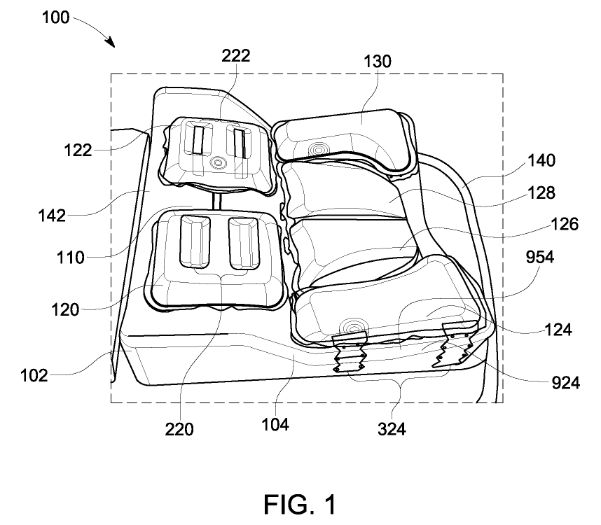

FIG. 1 depicts a cushion system 100. The cushion system 100 includes a cushion support 102 that serves as a foundation or support for the arrangement of multiple air bladders. The cushion support 102 may be constructed from a supportive material such as foam or a similar substance that provides structural integrity to the system.

In some embodiments, the cushion system 100 includes at least one air bladder. In some embodiments, the cushion system includes at least two air bladders arranged in a specific configuration on the cushion support 102. In some embodiments, the cushion system includes a plurality of bladders, wherein the bladders vary in at least one of size, shape, or function to provide customized support across different anatomical regions.

In some embodiments, the air bladders in the cushion system 100 may be constructed at least partially from elastic materials. As described in greater detail below, the elastic properties of the bladder materials may allow for volume expansion when there is a sudden increase in pressure, even without active or passive relief systems engaged. This expansion capability may provide an additional mechanism for impact dissipation. When an impact occurs, the elastic nature of the bladder material may allow it to stretch and deform, increasing its volume temporarily. This deformation may help absorb and distribute the energy from the impact.

In the embodiment depicted in FIG. 1, the cushion system 100 includes a left thigh bladder 120, a right thigh bladder 122, a left trochanter bladder 124, a right trochanter bladder 130, a left ischial tuberosity (IT) bladder 126, and a right IT bladder 128. One or more of these bladders may be configured to load tissue that supports one or more bony prominences when a user is seated on the cushion. For example, the trochanter bladders 124, 130 may be configured to load tissue that supports the greater trochanter, while the IT bladders 126, 128 may be configured to load tissue that supports the ischial tuberosities. The thigh bladders 120, 122 may be configured to load tissue that supports one or more bony prominences, e.g. the ischial tuberosity, the greater trochanter, and/or the femoral shaft in the thigh region, when the user is seated on the cushion.

In some embodiments, thigh bladders 120 and 122 are positioned proximal a front end of the cushion support 102. These thigh bladders may be designed to provide support and pressure distribution for a user's thighs. The thigh bladders 120 and 122 may have the same shape but different hose routing. The thigh bladders may be fluidly connected to maintain the same pressure, although in some embodiments they could be individually controlled. By adjusting the pressure in the thigh bladders, the height and load carried by a user's thighs may be modified. This adjustment capability may allow for changes in the angle at which a user's body sits in the chair. In some cases, increasing the pressure in the thigh bladders may effectively increase the distance between the cushion and a footplate, accommodating changes in footwear height or user growth without requiring adjustment of the footplate itself.

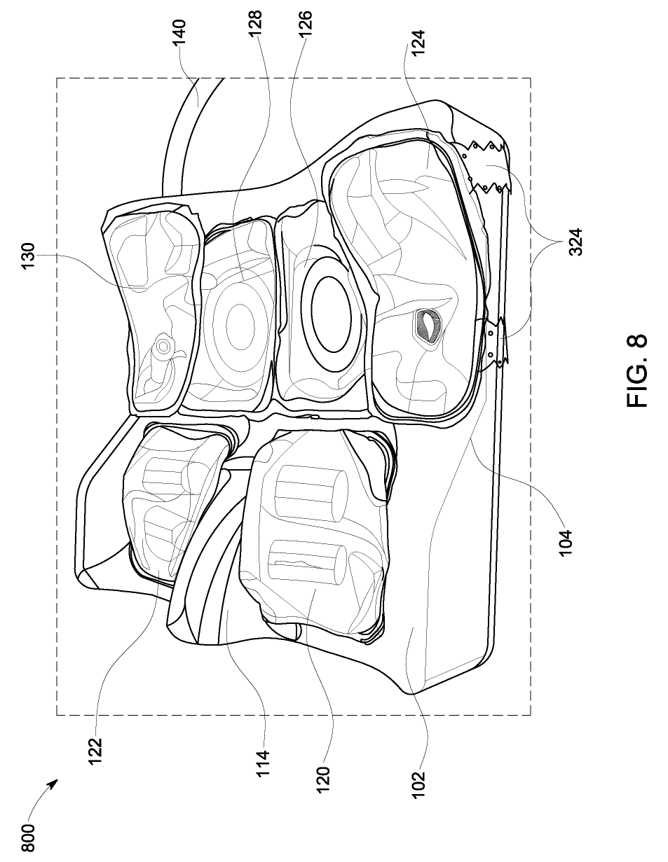

In some embodiments, an opening 110 may be positioned between the left thigh bladder 120 and the right thigh bladder 122, separating these two bladders. In some embodiments, such as in the cushion system 800 shown in FIG. 8, a medial thigh support 114 may be located in the opening 110. The medial thigh support 114 may be construed at least partially from a material such as foam and may rise above the surface on which the thigh bladders are positioned. This elevated structure may help prevent the user's thighs from sliding inward or the occupant from sliding their pelvis forward and out of the cushion. In some aspects, the medial thigh support 114 may be removable or adjustable, allowing for customization based on user needs or preferences. The size and/or shape of the medial thigh support 114 may thus be variable, providing flexibility in design to accommodate different user body types or seating requirements. This variability may allow for adjustments to the height, width, or contour of the medial thigh support 114 to optimize its effectiveness in maintaining proper user positioning while ensuring comfort.

In some embodiments, the cushion system 100 includes a row of bladders proximal a rear end of the cushion support 102. The row of bladders may include one or more trochanter bladders 124 and 130, positioned at the outer edges, and one or more IT bladders 126 and 128, located between them. The trochanter bladders 124 and 130 may be configured to support the hip region, while the IT bladders 126 and 128 may be designed to provide customized support for the ischial tuberosities.

In some embodiments, the trochanter bladders 124 and 130 may be mirrored in shape to each other and may be individually controllable. As these bladders inflate, they may be designed to cup around the pelvis, primarily supporting the load on the tissue that supports one or more bony prominences, such as the greater trochanter. This often refers to the muscle and fat that shifts to the back when a person sits down, while the trochanter is the joint that attaches to the hip. This configuration may allow for increased loading in these areas, as they may be at lower risk of pressure injuries compared to other regions. By providing targeted support to these anatomical structures, the trochanter bladders may help distribute pressure more effectively and potentially reduce the risk of discomfort or injury during extended periods of sitting.

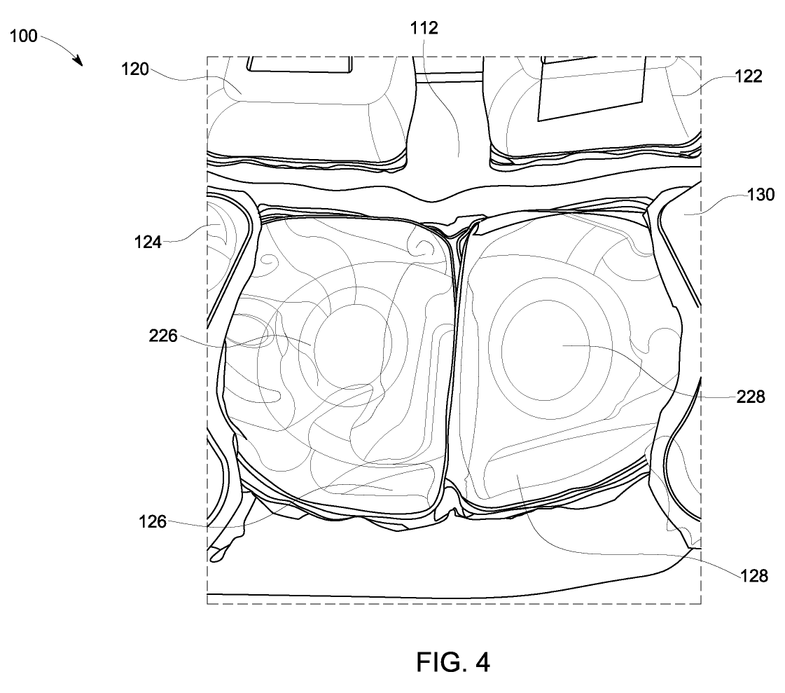

In some embodiments, the IT bladders 126 and 128 may be mirrored in shape to each other and individually controllable. These bladders may be designed to provide support and pressure distribution for the ischial tuberosities, which are the bony prominences at the bottom of the pelvis that bear a significant portion of body weight when seated. The individual control of these bladders may allow for precise adjustment of pressure and support in this critical area. In some embodiments, as shown in FIG. 4, the IT bladders 126, 128 may include contoured regions or materials 226, 228 (e.g., foam) positioned within the bladders. These contoured regions 226, 228 may be specifically shaped to match the curves of a user's ischial tuberosities, which are among the highest risk areas for developing pressure sores. The contoured foam regions 226, 228 ensure that even when the bladders are fully deflated, the user does not contact a hard surface beneath the cushion. This additional protection is critical to preventing injury in any scenario, including edge cases where air pressure might be lost or significantly reduced. By providing this failsafe cushioning layer within the IT bladders, the system helps maintain a minimum level of pressure distribution even in suboptimal conditions, thereby reducing the risk of tissue damage or pressure injuries.

In some embodiments, one or more hoses 140 may be fluidly connected to one or more of the air bladders, allowing for inflation and deflation control. This hose 140 may be routed along the cushion support 102 to connect with each of the air bladders in the system. The hose 140 may lead to a control system that regulates air flow to and from the bladders.

In some embodiments, the arrangement of the bladders in cushion system 100 creates distinct zones for supporting different areas of a user's body. This configuration may allow for individualized pressure management and support across various anatomical regions.

In some embodiments, the cushion system 100 may incorporate additional features such as pressure sensors, temperature regulators, or other components that enhance its adaptive capabilities. The specific shape, size, and arrangement of the bladders may be customized to suit different applications or user requirements.

In some embodiments, such as depicted in FIGS. 1-4, the different types of bladders (i.e., thigh, IT, trochanter) may have varying shapes and/or sizes. For example, the trochanter bladders 124, 130 may have a greater length than the other bladders and may include a curved or concave surface for receiving or abutting a portion of a respective IT bladder 126, 128. This configuration may allow the trochanter bladders to provide extended support along the hip region while accommodating the shape of the adjacent IT bladders.

In some cases, one or more of the air bladders may include at least one concave portion or surface. The concave portion or surface may allow the bladder to better receive a convex portion of the user's body, creating a complementary interface that enhances contact and support. This concave configuration may conform to the natural curves and contours of the user's anatomy, such as the rounded surfaces of the hips, thighs, or other body regions. By providing a recessed area that matches the convex shape of the user's body, the concave portion may increase the surface area of contact between the bladder and the user, which may help distribute pressure more evenly across a larger area. In some embodiments, the concave portion may be designed to cradle specific anatomical features, allowing the bladder to wrap around or partially enclose convex body parts. This cradling effect may provide enhanced stability and support by creating a more secure interface between the user and the cushion system. The concave shape may also help prevent the user from sliding or shifting position during use, as the recessed area may provide a natural seating position that encourages proper alignment. By using non-symmetrical shapes and other features described herein, the bladders and cushion overall may load tissue in a more supportive, distributed way.

In some embodiments, at least two of the air bladders, when at least partially inflated, may be configured to form a more continuous surface relative to a non-inflated state of the at least two bladders. The bladders may work together when inflated to create this more continuous surface, which may provide increased surface area for the user's body to contact. This increased contact area may help distribute pressure more evenly across the user's anatomy and may reduce the formation of pressure points that could occur with discrete, separated bladder surfaces. In some aspects, when the bladders inflate, they may move towards each other, reducing gaps or spaces that may exist between them in their deflated state. This movement may create a more unified support surface that conforms more closely to the user's body contours. In some embodiments, the bladders may overlap when inflated, with one bladder extending at least partially over top of another bladder. For example, trochanter bladder 124 may at least partially overlap with IT bladder 126 vertically, or vice versa. Similarly, trochanter bladder 130 may at least partially overlap with IT bladder 128, or vice versa. Additionally, IT bladder 126 may at least partially overlap with IT bladder 128, or vice versa. This overlapping configuration may help eliminate discontinuities in the support surface and may provide smoother transitions between different support zones. The formation of a more continuous surface through bladder interaction may be particularly beneficial in areas where multiple bladders are positioned adjacent to each other, such as between the trochanter bladders and IT bladders, or between the thigh bladders and the rear bladder array. When these bladders inflate and work together to form a more continuous surface, they may provide enhanced comfort and support by creating a more seamless seating experience for the user.

In some embodiments, one or more of the bladders in the cushion system 100 may be manifolded together to create interconnected pressure zones. For example, the left trochanter bladder 124 and right trochanter bladder 130 may be fluidly connected through a manifold system, allowing them to inflate and deflate simultaneously. This configuration may enable coordinated lifting of both trochanter regions at the same time, which may help redistribute pressure away from the ischial tuberosity (IT) areas. By manifolding the trochanter bladders together, the system may provide more balanced and symmetrical support to the user's hip regions. When these manifolded bladders are inflated, they may work in tandem to elevate the outer edges of the pelvis, reducing pressure on the IT bladders 126 and 128. This coordinated action may be particularly beneficial for users who require periodic pressure relief or repositioning to prevent discomfort or the development of pressure injuries.

In some embodiments, the manifolded bladders may be controlled by a single valve or pressure regulator, simplifying the control mechanism while still allowing for targeted pressure management. The manifold system may include pressure equalization pathways that ensure uniform distribution of air or fluid between the connected bladders, promoting consistent support across the linked zones. Additionally, manifolding may be applied to other bladder combinations within the cushion system 100. For instance, the left IT bladder 126 and right IT bladder 128 could be manifolded to provide synchronized support to the ischial tuberosities. Similarly, the left thigh bladder 120 and right thigh bladder 122 may be interconnected to ensure balanced thigh support.

The use of manifolded bladders may offer advantages in terms of system simplification, coordinated pressure management, and the ability to create larger, more responsive support zones within the cushion system 100. This approach may enhance the system's capability to adapt to various user needs and seating scenarios while maintaining individualized support for different anatomical regions.

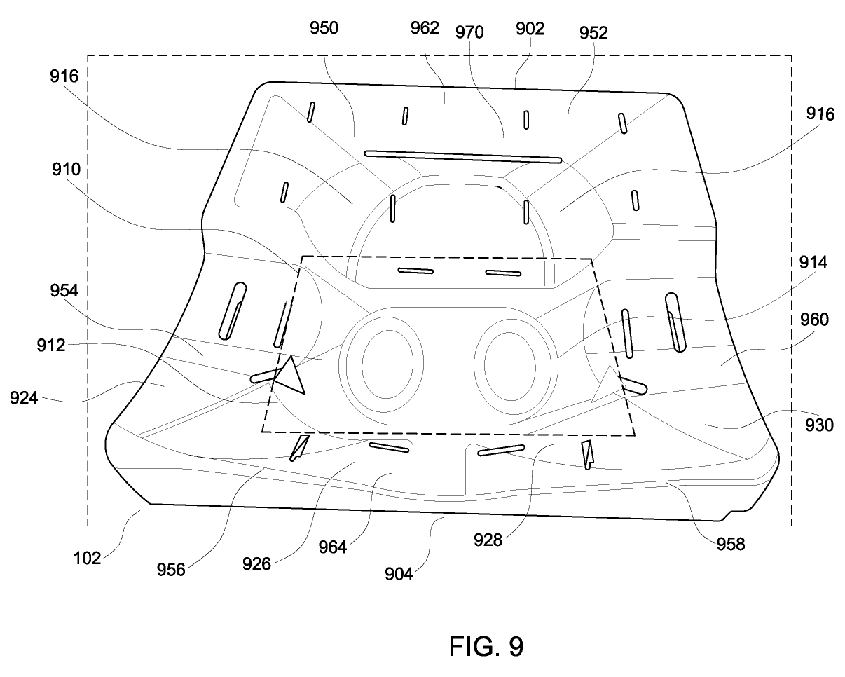

As will be described in greater detail in reference to FIG. 9, one or more of the bladders may be positioned on or above contoured surfaces or portions of the support 102. For example, as depicted in FIG. 1, the trochanter bladder 124 may be at least partially positioned on or above a receiving portion 924 that includes a contoured surface 954. This contoured surface 954 may help to orient the trochanter bladder 124 at a specific angle or position relative to the other bladders and the user's anatomy. In some embodiments, the support may be symmetrical such that trochanter bladder 130 is positioned on its own respective receiving portion 930 that is located opposite of receiving portion 924 and includes a contoured surface 960. The use of contoured surfaces on the support 102 may allow for more precise positioning and support of each bladder, enhancing the overall effectiveness of the cushion system in providing customized pressure distribution and comfort. In some embodiments, the contoured surfaces may vary in height, angle, or curvature to accommodate the different shapes and sizes of the bladders. This variability in the support structure may contribute to the cushion system's ability to provide targeted support to specific anatomical regions while maintaining overall comfort and stability for the user.

As depicted in FIGS. 1-3, the cushion system 100 may include a pelvic ridge 104 and one or more lateral thigh supports 106, 108. This pelvic ridge 104 may provide additional support and help maintain proper positioning of the user's pelvis. The pelvic ridge 104 may represent an increase in height that may begin gradually between the thigh bladders 120, 122 and the row of bladders 124, 126, 128, 130 towards the rear of the cushion. This gradual elevation may allow the thigh bladders and lateral thigh supports to be positioned at a higher level relative to other areas of the cushion. The elevated positioning may help maintain proper pelvic orientation for the user and may increase the proportion of load carried by the thigh bladders. By redistributing more load to the thigh region, the pelvic ridge 104 may reduce the load carried by the user's pelvis. In some aspects, the height of the pelvic ridge 104 may influence the "seat dump" of the cushion, which refers to the angle or slope from the rear of the cushion to the front. A more pronounced seat dump, which may be achieved through a higher pelvic ridge, may enhance stability by effectively lowering the user's center of gravity when seated on the cushion.

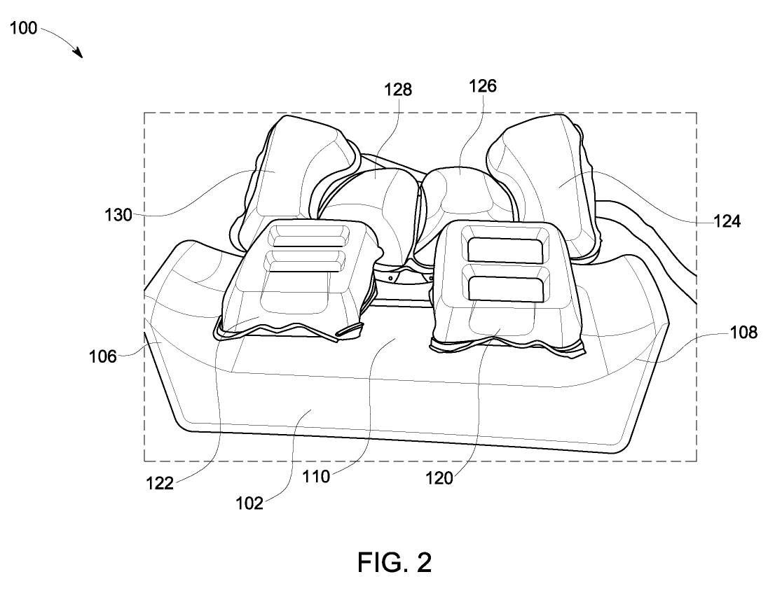

FIG. 2 depicts a front view of the cushion system 100. In some embodiments, lateral thigh supports 106, 108 may be incorporated into the cushion system 100 and may help prevent the user's thighs from sliding to the outer edges of the cushion. The lateral thigh supports 106, 108 may provide additional stability and containment for the user's lower body. In some embodiments, the lateral thigh supports may be symmetrical, while in other aspects they may be asymmetrical to accommodate specific user needs or anatomical variations. The design and positioning of the lateral thigh supports may be customized to optimize user comfort and positioning based on individual requirements or preferences.

The cushion support 102 may include top surface 142 on which the air bladders may be positioned and a bottom surface 144 that engages with a supporting surface. In some embodiments, the bottom surface may be substantially planar or flat. In some embodiment, the top surface 142 may include one or more contoured or angled regions or portions such that the top surface 142 is not planar or flat. In some embodiments, one or more internal bladder inflation reduction straps 220, 222 may be provided within one or more of the air bladders. In some embodiments, one or more internal bladder inflation reduction straps may be provided within each of the air bladders. In the embodiment depicted in FIGS. 1-3, multiple internal bladder inflation reduction straps 220 are positioned within thigh bladder 120 and multiple internal bladder inflation reduction straps 222 are positioned within thigh bladder 122. In some embodiments, the straps may modify the shape and inflation characteristics of the air bladders. The thickness of the air bladders may vary across their cross-section, which may be achieved through heating and shaping processes. This non-uniform thickness may allow for variable elasticity within a single air cell and enable multidimensional shape changes at different air pressures.

In some embodiments, material may be welded inside the bladders to further influence their inflation behavior. The internal bladder inflation reduction straps 220, 222 integrated into the thigh bladders may serve to reduce the concavity of the inflated air bladder. This reduction in concavity may increase the contact area between the bladder and the user's thighs. Additionally, the flattened surface created by these straps may help prevent the user from sliding laterally on the cushion. The internal straps 220, 222 may also allow for customization of the bladder shape when inflated. By strategically positioning these straps, the cushion system may be tailored to provide optimal support and pressure distribution for different user body types and seating requirements.

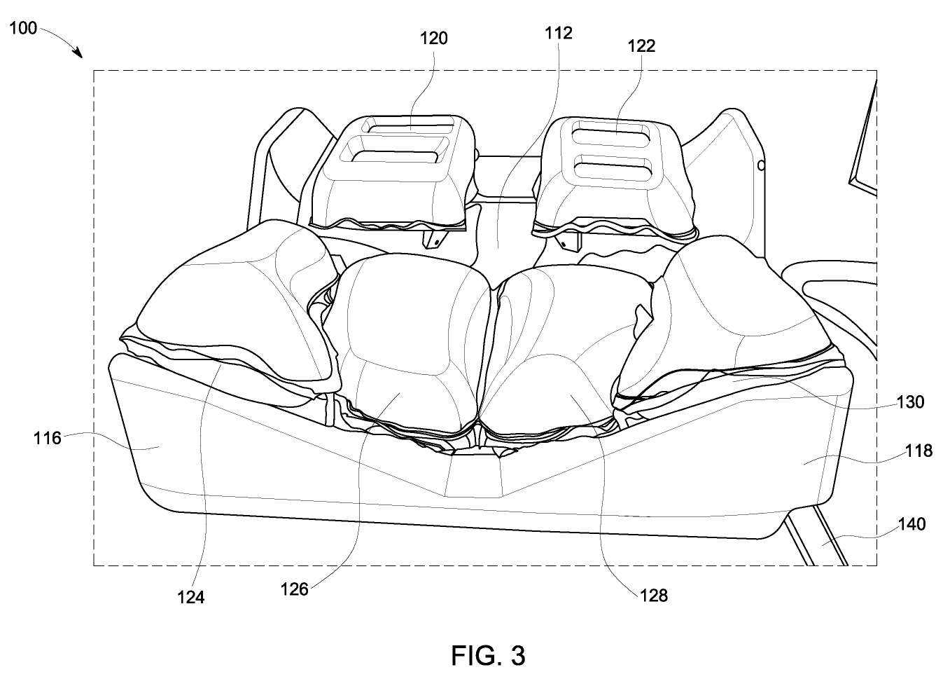

FIG. 3 depicts a rear view of the cushion system 100. In some embodiments, one or more pelvic supports 116, 118 may be integrated into the cushion system 100. The lateral pelvic supports 116, 118 may be designed to lift and angle the trochanter bladders 124, 130 towards the center of the cushion. This configuration may increase the amount of load carried by the trochanters, enabling more load to be redistributed from the IT bladders 126, 128. The angled orientation of the lateral pelvic supports 116 may provide several benefits. As pressure increases in the trochanter bladders 124, 130, the angled supports may cause the bladders to press inward, which may help lift the user. This lifting action may contribute to increased stability for the user when seated on the cushion system 100.

In some embodiments, the lateral pelvic supports 116, 118 may be adjustable or customizable to accommodate different user body types or specific support needs. The height, angle, or firmness of the lateral pelvic supports 116, 118 may be modified to optimize load distribution and stability for individual users. The lateral pelvic supports 116, 118 may work in conjunction with other features of the cushion system 100, such as the pelvic ridge 104 and the medial thigh support 114, to provide comprehensive pelvic and lower body positioning. This integrated approach to support may help maintain proper anatomical alignment and enhance overall seating comfort and stability.

In some embodiments, a scrotal well 112 may be formed or provided in a central region. In some embodiments, the scrotal well 112 may be formed by removing foam or other material from the central region between the thigh bladders. This removal of material may create a recessed area, often referred to as the scrotal well, which may provide space to accommodate the scrotum. The dimensions and shape of the scrotal well 112 may be customized based on individual user needs. By creating this dedicated space, pressure on the scrotum may be reduced, which may enhance comfort for male users. The scrotal well 112 may be designed with gradually sloping edges to ensure a smooth transition from the surrounding cushion surface. In some cases, the depth and width of the scrotal well 112 may be adjustable to accommodate different body types and user preferences. The incorporation of the scrotal well 112 may contribute to improved overall seating comfort and may help prevent discomfort or potential health issues associated with prolonged pressure on sensitive anatomical areas.

As depicted in FIG. 4, regions 226 and 228 may be contoured within the IT bladders. In some embodiments, these regions may be contoured to match the curves of a user's buttocks. The regions may be designed to provide support for the ischial tuberosities (ITs) in case the air pressure in the bladders becomes very low, causing the user to sink to the bottom of the cushion. This phenomenon is sometimes referred to as "bottoming out."

The contoured regions 226 and 228 may serve as a safety feature, ensuring that even if the air pressure in the bladders is significantly reduced, the user's ITs will still have a supportive surface to rest on. This may help prevent discomfort and potential pressure points that could occur if the user were to contact a hard surface beneath the bladders.

In some embodiments, the regions 226 and 228 may be made from a different material from the material used for the support 102. For example, different types of foam with varying densities or compression characteristics may be used for the regions 226, 228. In some embodiments, a liquid material such as gel may be employed instead of or in addition to the material used for the support (e.g., foam). The choice of material may depend on factors such as desired cushioning properties, durability, and heat dissipation characteristics. The contoured shape of the regions 226 and 228 may help distribute pressure more evenly across the user's sitting surface, reducing the risk of pressure sores or discomfort during extended periods of sitting. The regions may work in conjunction with the air bladders to provide a comprehensive support system that adapts to the user's body shape and movement.

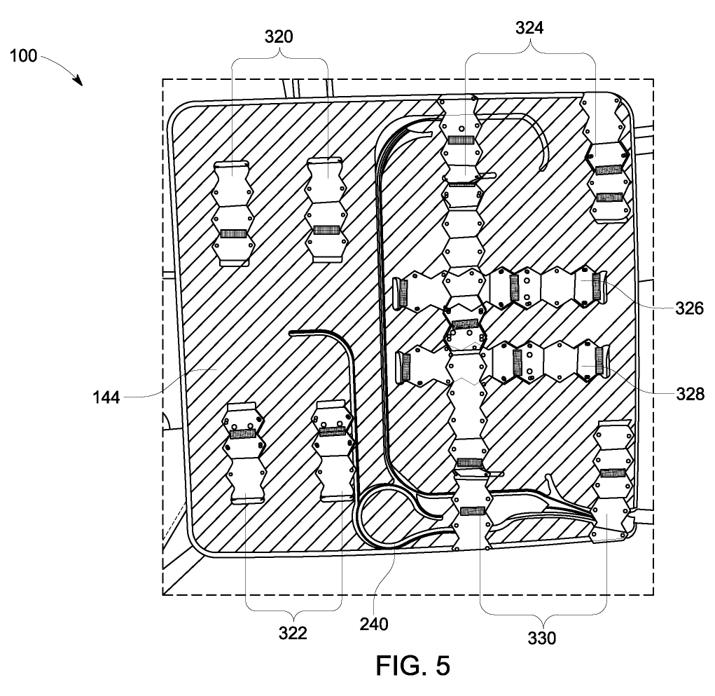

FIG. 5 depicts a bottom surface 144 of the support 102. In some embodiments, the system includes bladder attachment straps 320, 322, 324, 326, 328, 330. In some embodiments, as depicted in FIG. 5, each of the bladders 120, 122, 124, 126, 128, 130 has one or more respective bladder attachment straps 320, 322, 324, 326, 328, 330. For example, FIG. 1 depicts the use of straps 324 for bladder 124. In some embodiments, the system includes a bladder hose routing 240.

In some embodiments, the bladder attachment straps 320, 322, 324, 326, 328, 330 shown in FIG. 5 may vary in length and provide a semi-flexible attachment method for securing the air bladders to the cushion support. This flexible attachment may allow the bladders to inflate and experience side loading while remaining forgiving to the user if they sit or slide their bottom parallel to the cushion surface. By utilizing these straps instead of direct attachment points in the foam itself, the cushion may avoid creating hard points that a user could feel when sitting. Additionally, this attachment method may be less likely to wear out or pull out over time compared to direct foam attachments.

The bladder attachment straps 320, 322, 324, 326, 328, 330 may be secured to the cushion support using various methods. In some embodiments, ultrasonic welding may be employed to attach the straps. Other attachment techniques may include the use of elastic straps or pins to hold down the bladders. The choice of attachment method may depend on factors such as manufacturing processes, durability requirements, and ease of assembly or replacement.

In some embodiments, alternative attachment mechanisms and methods may be employed for securing the bladders to the support and maintaining their position. These alternatives may include adhesive bonding using specialized glues or epoxies that provide a strong yet flexible connection between the bladders and the support surface. In some cases, pin systems may be utilized, where small, strategically placed pins or pegs protrude from the support surface and engage with corresponding receptacles on the bladders. Hook-and-loop fastener systems, such as Velcro, may be implemented in some embodiments to allow for adjustable and removable bladder attachment. Stapling techniques using specialized medical-grade staples may be employed in certain configurations to provide a secure connection while minimizing potential discomfort. The choice of attachment method may depend on factors such as the specific bladder material, support surface composition, desired adjustability, and manufacturing considerations. These alternative attachment methods may be used individually or in combination to achieve optimal bladder securement and positioning within the cushion system.

In some embodiments, the one or more hoses 140 may be utilized to assist in securing the bladders in position on the cushion support. The hoses 140 may be routed through channels or along specific paths on the cushion support, creating a network that not only provides air to the bladders but also helps to anchor them in place. This dual-purpose functionality of the hoses 140 may contribute to the overall stability of the bladder arrangement while reducing the need for additional attachment mechanisms. The strategic routing of the hoses 140 may allow for some degree of bladder movement during inflation and user movement, while still maintaining the general positioning of the bladders within the cushion system.

FIG. 5 also depicts the bladder hose routing 240, which may show the pathways for one or more air hoses connecting the air bladders to the control box 140. In some embodiments, these routing channels may be machined into the foam or support material with a width designed to prevent the hoses from falling out due to gravity alone. This design feature may eliminate the need for secondary retention methods to hold the tubing in place, potentially simplifying the assembly and maintenance of the cushion system. The bladder hose routing 240 may be configured to organize and protect the air hoses as they travel from various bladder locations to a central connection point for the control box 140. In some cases, if a hose begins to come loose from its routing channel, the inner cover of the cushion may provide an additional layer of containment, helping to keep the hose in place and maintain the overall organization of the cushion's internal components.

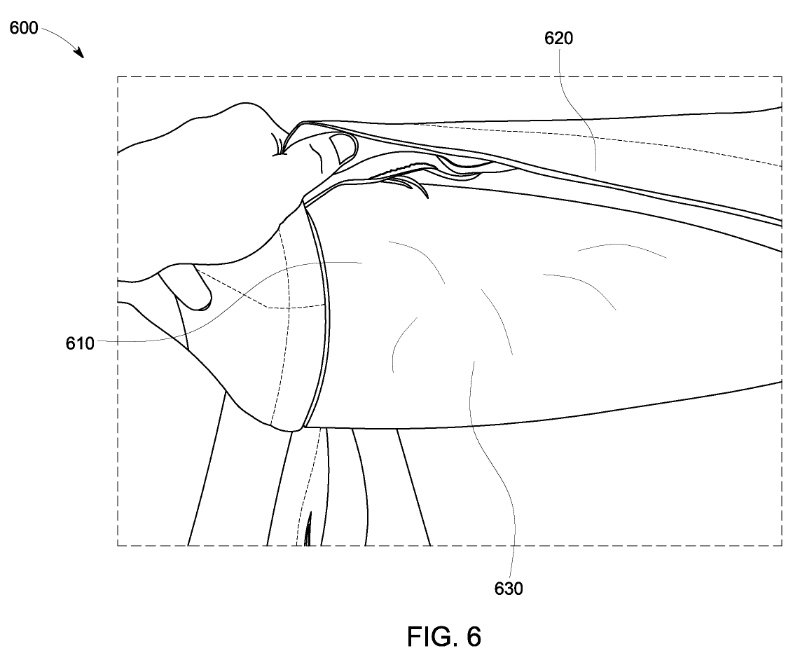

FIG. 6 depicts a cover assembly 600 for a cushion. The assembly includes multiple layers that work together to provide comfort, protection, and functionality. In some embodiments, the cover assembly 600 may include a layer 610 (e.g., a foam layer) positioned between an outer material 620 and an inner material 630. The layer 610 may serve as a topper layer that is not rigidly attached to the rest of the cushion, allowing it to move and shift without tearing. This flexibility may enhance the cushion's ability to conform to the user's body shape and movements. In some aspects, the layer 610 positioned above the air bladders may have a lower surface pressure required for displacement compared to the foam or other materials beneath it. This softer top layer may help distribute pressure more evenly across the user's body. Additionally, the layer 610 may function to smooth out the surface of the cushion when the bladders are inflated, potentially reducing pressure points that could be created by the bladders themselves.

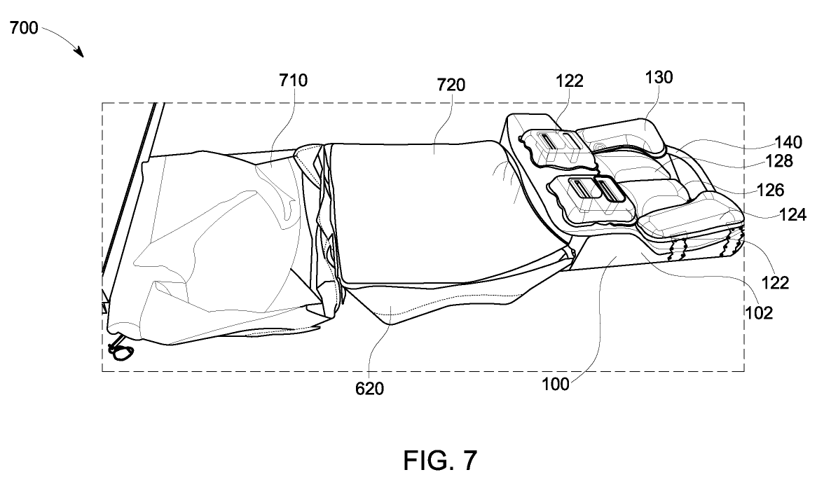

In some embodiments, the outer material 620 may be a water-resistant yet stretchy material. This layer may serve as a barrier to prevent liquids such as urine, sweat, or rain from reaching the internal components of the cushion. The water-resistant properties of the outer material 620 may help protect the cushion's internal structure and extend its lifespan. In some embodiments, this outer material 620 may be part of an inner cover 720, which (as will be described in greater detail with respect to FIG. 7) may be designed to be removable independently of an outer cover 710. This feature may allow for easier cleaning and maintenance of the cushion assembly.

In some embodiments, the inner material 630 may be a breathable and highly stretchable material. This layer may be designed to reduce shear forces when a user immerses into the cushion, compared to the water-resistant outer material of the inner cover. The breathable nature of this material may help manage moisture and heat, potentially enhancing user comfort during extended periods of sitting. The high stretch properties of the inner material 630 may allow it to conform closely to the user's body shape, improving pressure distribution and overall comfort.

The use of one or more of these layers may create a cushion assembly that balances comfort, protection, and functionality. The multi-layered approach depicted in FIG. 6 may allow the cushion to adapt to various user needs and environmental conditions while maintaining its structural integrity and performance.

FIG. 7 depicts a cushion assembly 700. The cushion assembly 700 includes a cushion system 100, which as described with respect to FIG. 1 includes a cushion support 102 and a plurality of air bladders 120, 122, 124, 126, 128, 130. In some embodiments, an inner cover 720 is designed to encase the cushion system 300. The inner cover 720 may incorporate a water-resistant outer material that may be stretchy to accommodate the shape of the internal components. This water-resistant material may serve as a barrier to prevent liquids such as urine, sweat, or rain from reaching the internal components of the cushion. This feature may be particularly beneficial for users who may experience incontinence or in outdoor applications where moisture protection is necessary.

In some embodiments, the inner cover 720 may be removable independently of an outer cover 710. This design may allow the inner cover 720 to function as an adequate cushion cover even when the outer cover 710 is removed, such as during cleaning or maintenance. This feature may enable users to continue using the cushion while the outer cover 710 is being washed or replaced.

In some embodiments, the outer cover 710 forms the outermost layer of the cushion system 100. The outer cover 710 may also incorporate a stretch and/or water-resistant material. In some aspects, the outer surface of the outer cover 710 may have a lower coefficient of friction compared to the outer surface of the inner cover 720. This property may help reduce friction between the cushion and the user's clothing, enhancing comfort and ease of movement.

In some implementations, the outer cover 710 may be customizable based on specific requirements. For instance, users may have the option to use an outer cover 710 with either air-permeable or water-resistant properties, depending on the intended use case or user needs.

In some embodiments, an opening 110 may be positioned between the left thigh bladder 120 and the right thigh bladder 122, separating these two bladders. In some embodiments, such as in the cushion system 800 shown in FIG. 8, a medial thigh support 114 may be located in the opening 110. The medial thigh support 114 may be construed at least partially from a material such as foam and may rise above the surface on which the thigh bladders are positioned. This elevated structure may help prevent the user's thighs from sliding inward or the occupant from sliding their pelvis forward and out of the cushion. In some aspects, the medial thigh support 114 may be removable or adjustable, allowing for customization based on user needs or preferences. The size and/or shape of the medial thigh support 114 may thus be variable, providing flexibility in design to accommodate different user body types or seating requirements. This variability may allow for adjustments to the height, width, or contour of the medial thigh support 114 to optimize its effectiveness in maintaining proper user positioning while ensuring comfort.

FIG. 9 depicts a top view of cushion support 102 with various contoured surfaces and receiving portions for air bladders. The cushion support 102 extends from a front end 902 of support 102 to a rear end 904 of support 902. The cushion support 102 includes a pelvic well 910 defined by an outer perimeter 912 and an inner perimeter 914. In some embodiments, the outer perimeter 912 may have a cross-sectional width of less than 10 inches and a depth of less than 7 inches. In some embodiments, the inner perimeter 914 may have a cross-sectional width less than 8 inches and a depth of less than 6 inches. The pelvic well 910 may be a contoured section shaped to accommodate an occupant's pelvis. In some aspects, when customizing cushion dimensions, the width and depth of the curved foam beneath the IT bladders may not increase proportionally with the overall width and depth of the cushion. The angles on the edge and the flattest points in the well may change less than the amount of width or depth increase. For example, an 18-inch wide cushion may not have a pelvic well that is 2 inches less wide than a 20-inch wide cushion.

In some embodiments, one or more thigh ramps 916 extend from the pelvic well 910 toward the front end 902. These ramps may help prevent pressure increases on the inner thighs when the foam under the pelvis and thighs are at different thicknesses relative to each other. The thigh ramps 916 may accommodate the tendency of thighs to sit at an angle such that the knees end up wider than the pelvis.

The rear end 904 may include receiving portions or sections for multiple bladders. A receiving portion for left trochanter bladder 924 and a receiving portion for right trochanter bladder 930 may be positioned proximate the rear corners. Between these may be a receiving portion for left IT bladder 926 and a receiving portion for right IT bladder 928. The front portion of the support may include a receiving portion for left thigh bladder 920 and a receiving portion for right thigh bladder 922.

The cushion support 102 may include one or more contoured surfaces. In some embodiments, the support may include contoured surface 954, contoured surface 956, contoured surface 958, and/or contoured surface 960. These contoured surfaces provide varying heights and angles across the support surface. By placing air bladders on surfaces that are not planar to the bottom of the cushion, the bladders may be able to expand laterally based on the air pressure within the bladder and the shape of the occupant. This configuration may allow for more customized support and pressure distribution.

In some embodiments, the air bladders may be positioned above or over the contoured portions of the support, rather than directly on them. This configuration may allow the bladders to initially float or suspend above the contoured surfaces when unloaded. When a user sits on the cushion, the weight and pressure may cause the bladders to bend or deform downward, eventually making contact with the contoured portions of the support beneath them. The initial suspension of the bladders above the contoured surfaces may allow for greater initial compliance and softness when the user first sits down. As the user's weight is applied, the bladders may gradually conform to both the user's body shape and the underlying contoured support surface. This progressive engagement may help to distribute pressure more evenly and reduce the likelihood of pressure points forming.

A central portion of front end 962 is positioned at the front end of support 902, while a central portion of rear end 964 is positioned at the rear end of support 904. In some embodiments, central portion 962 may comprise a planar or substantially planar surface. In some embodiments, central portion 964 may comprise a planar or substantially planar surface and the cushion support 102 may extend at an angle or incline towards the corners of the support away from the central portion 964. This arrangement creates a height differential between the central region and the corner regions of the support, which may allow the trochanter bladders 124, 130 positioned in these corner regions to extend vertically higher than the IT bladders 126, 128. The elevated positioning of the trochanter bladders relative to the IT bladders helps redistribute pressure away from the ischial tuberosities and toward the trochanters, which can better tolerate pressure. This configuration may be particularly beneficial for users who are at risk of developing pressure injuries, as it reduces pressure on the bony prominences of the ischial tuberosities while maintaining proper pelvic positioning and support.

In some embodiments, an opening 970 (e.g., a slot as depicted in FIG. 9) may extend between the thigh bladders 120, 122. In some embodiments, the opening 970 may serve as an accommodation point for a removable or adjustable medial thigh support 114. In some embodiments, the opening 970 may provide a channel for routing control components, such as air hoses or electrical wiring, between the front and rear portions of the cushion. This configuration may allow for more organized and protected placement of these components within the cushion structure. In some embodiments, the opening 970 may function as a pressure relief zone, allowing for localized decompression in the central region between the thigh bladders. This feature may help reduce pressure on sensitive anatomical structures in the perineal area when a user is seated on the cushion.

The arrangement of contoured surfaces for bladders as depicted in FIG. 9 demonstrates how the cushion support 102 may be designed to provide targeted support for different anatomical regions while allowing for customization and adaptability to individual user needs.

In some embodiments, the foam design and layout of the cushion support may incorporate contoured surfaces that create height differentials for the air bladders. In some embodiments, the contoured surfaces may have height changes of 0.5 inches or greater, allowing the air bladders to be positioned at varying elevations and angles. This design approach may enable more targeted support and pressure distribution for different anatomical regions.

In some embodiments, the cushion system may allow for customization beyond standard width and depth selections. In some cases, users or clinicians may request modifications to features such as the pelvic ridge, lateral pelvic support, scrotal well, or medial thigh support. Based on these selections, the support and/or air bladders may be manufactured to order, providing a highly personalized cushion solution.

The cushion system may incorporate adjustable settings, such as a base pressure state, that can be modified over time. This feature may allow for ongoing customization of the cushion to accommodate changes in the user's needs or body shape throughout the life of the cushion.

In some embodiments, the air bladders may be shaped to match the curves of an occupant's body rather than following a standard pattern or shape optimized for ease of manufacture. The bladders may be produced in varying sizes depending on the requested cushion dimensions and feature selections, enabling optimal fitment for each user's unique body shape.

The arrangement of air bladders in the rear portion of the cushion, as shown in FIG. 1, may include separate control surfaces for each trochanter and IT bladder. This configuration may allow for maximum postural accommodations and targeted pressure relief while minimizing the number of individual control cells required. In some cases, fewer bladders may reduce the number of controllable surfaces, which may lead to inadvertent pressure points during offloading maneuvers.

The arrangement of air bladders may be adjusted or tailored for specific conditions or diagnoses of a particular. For example, for users with leg amputations, the bladder positioning and sizing may be modified to ensure stability while minimizing interface pressure on the ischial tuberosities. Similarly, leg-length discrepancies may be accommodated by eliminating a thigh bladder or adjusting the cushion length on one side to provide appropriate support.

In some embodiments, an additional air bladder may be placed between the back and front rows of bladders to provide a smoother transition. In some embodiments, this intermediate bladder may be controllable. In some embodiments, this intermediate bladder may not be controllable.

In some aspects, the shape of the air bladders may be modified through heating and shaping processes to create non-uniform thickness across the bladder cross-section. This approach may allow for variable elasticity within a single air cell and enable multidimensional shape changes at different air pressures. Additionally, material may be welded inside the bladders to influence their inflation behavior. For example, as described in reference to FIG. 1, internal bladder inflation reduction straps may be integrated into one or more of the bladders (e.g., in the thigh region) to reduce the concavity of the inflated air bladder. This feature may increase the contact area with the user's thighs and create a flatter surface that helps prevent lateral sliding.

In some embodiments, the air bladders may be constructed with varying material thicknesses to achieve different levels of stiffness when inflated. This approach may allow for customization of immersion and postural support characteristics between different air bladders, and even within a single air bladder if the top sheet and bottom sheet are made from different materials. For example, a bladder may have a thicker, stiffer material on the bottom for stability, while using a thinner, more flexible material on the top to allow for greater conformity to the user's body shape. This variability in material thickness may also provide more flexibility in the manufacturing process of the air bladders. The process of attaching the two sides of the bladder may be tailored to accommodate different material thicknesses, allowing for more efficient production methods or the use of specialized bonding techniques. By strategically varying the material properties of the bladders, the cushion system may be able to provide more targeted support and pressure distribution across different anatomical regions, potentially enhancing overall comfort and postural stability for the user.

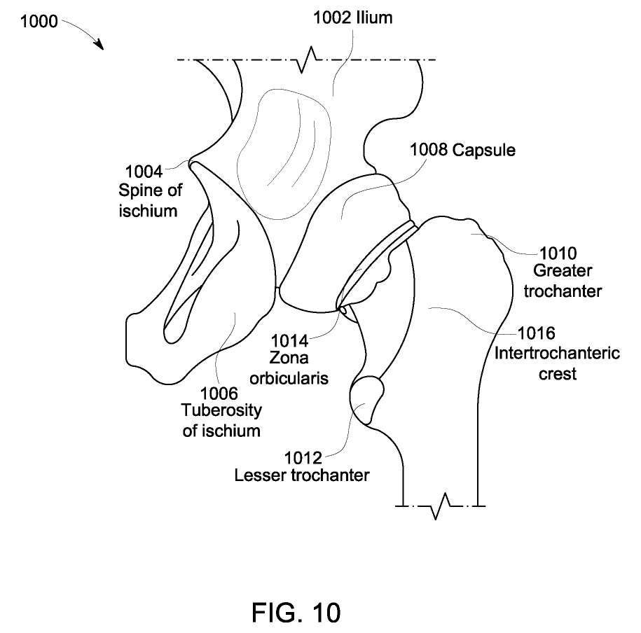

FIG. 10 depicts a portion of human pelvic anatomy, providing context for understanding the design considerations of the cushion system. The figure depicts key anatomical structures that influence pressure distribution and support requirements when seated. The ilium 1002, which is the uppermost and largest part of the pelvic bone 1000, provides attachment points for various muscles and helps distribute body weight when seated. Extending from the posterior region of the pelvic bone 1000 is the spine of ischium 1004. This bony projection serves as an attachment point for ligaments and muscles. Below the spine of ischium 1004 is the tuberosity of ischium 1006, an important structure in seated postures. The tuberosity of ischium 1006 bears a significant portion of body weight when seated and may be particularly susceptible to pressure-related discomfort or injury during prolonged sitting.

Surrounding the hip joint area is the capsule 1008, a fibrous structure that encloses the joint and provides stability. The capsule 1008 plays a role in maintaining proper joint alignment and may influence the distribution of forces across the hip region. Two prominent bony landmarks on the upper part of the femur are also visible: the greater trochanter 1010 and the lesser trochanter 1012. These structures serve as attachment points for various muscles and may influence the distribution of pressure and support needed in a seating system. The zona orbicularis 1014, a ring-like ligamentous structure, encircles the femoral neck region. While not directly weight-bearing, this structure contributes to joint stability and may influence the overall biomechanics of the hip region when seated.

In some embodiments, the cushion system may be configured to redistribute pressure away from sensitive areas such as the tuberosity of ischium 1006 and towards regions that can better tolerate pressure, such as the areas supported by the ilium 1002 or the muscular regions around the greater trochanter 1010. This anatomically-informed approach to cushion design may help in reducing the risk of pressure-related discomfort or injury, particularly for users who spend extended periods in a seated position.

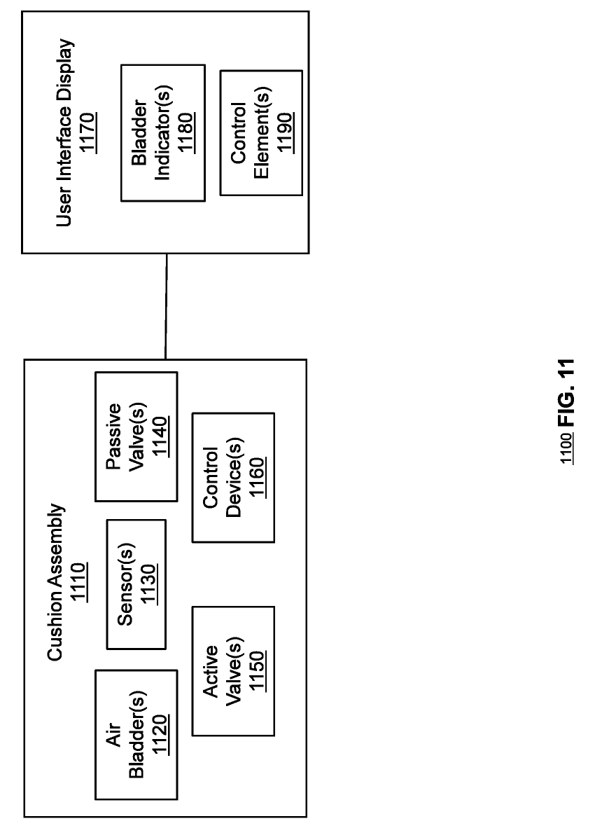

FIG. 11 depicts a cushion system 1100 that includes various components for providing adjustable support and pressure distribution. The cushion system 1100 comprises a cushion assembly 1110 that incorporates one or more air bladders 1120, one or more pressure sensors 1130, one or more passive valves 1140, and one or more active valves 1150.

In some embodiments, the air bladders 1120 may be arranged in multiple zones within the cushion assembly 1110. As described in reference to FIGS. 1-3, each zone may correspond to different anatomical regions, such as the thighs, hips, or ischial tuberosities. The air bladders 1120 may vary in size, shape, or volume to provide targeted support to specific body areas.

In some embodiments, the pressure sensors 1130 may be strategically placed within the cushion assembly 1110 to monitor pressure distribution across the support surface. In some aspects, these sensors may provide real-time data on the pressure exerted by the user's body on different areas of the cushion. This information may be used to detect pressure points or areas of high pressure that may require adjustment.

In some embodiments, the cushion system 1100 may include passive valves 1140 and/or actively controlled valves 1150 for controlling air flow within the air bladders 1120. Passive valves 1140 may operate without external control, responding to pressure changes automatically. Active valves 1150 may be electronically controlled to adjust air flow based on sensor data or user input.

In some embodiments, at least one bladder of the air bladders 1120 may include one or more portions or regions that are structurally modified relative to one or more other portions or regions of the bladder. This structurally modified portion may be configured to rupture in a controlled manner when subjected to a predetermined pressure, allowing air to vent at a predetermined rate through the resulting opening in the at least one bladder.

In some embodiments, a control device 1160 may be integrated into the cushion system 1100 to manage the operation of various components. In some embodiments, the control device 1160 or components thereof may be located inside or integrated into a cushion support. This configuration may allow for a more compact and self-contained cushion system 1100. The integration of the control device 1160 within the cushion support may provide protection for the electronic components and reduce the need for external connections. In some embodiments, the control device 1160 or components thereof may be positioned external to the cushion support. When located externally, the control device 1160 may be connected to the cushion system 1100 through various means. In some embodiments, a wired connection may be used to link the external control device 1160 to the components within the cushion assembly 1110. This wired connection may provide a direct and reliable communication pathway for data transmission and control signals. In some embodiments, the external control device 1160 may utilize wireless communication technologies to interface with the cushion system 1100. Wireless connectivity may offer greater flexibility in terms of control device placement and may reduce the need for physical cable connections. Various wireless protocols may be employed, such as Bluetooth, Wi-Fi, or proprietary wireless standards, depending on the specific requirements of the application.

In some embodiments, the control device 1160 may process data from the pressure sensors 1130, control the active valves 1150, and/or interface with external systems or user interfaces. In some embodiments, the control devices 1160 may include controllers, microprocessors, memory units, and communication modules to enable sophisticated control algorithms and data logging capabilities. In some embodiments, the cushion system 1100 may include a control device connected to the cushion assembly 1110 by an air hose. The control device may be configured to sense pressure in one or more of the air bladders 1120, provide air to the bladders, and/or vent air from the bladders. In some implementations, the cushion assembly 1110 may include a single inlet for receiving air, allowing the control device to manage air flow for multiple bladders through a centralized connection point. In some embodiments, the control device may incorporate various components within a compact enclosure, such as an injected molded enclosure. These components may include an inlet/outlet port, a pump, a vent, a pressure sensor, a processor, and/or a memory. In some aspects, the control device may be designed to be handheld, allowing for easy manipulation by a user of the cushion or a caregiver.

In some embodiments, the control device may be pneumatically coupled to the cushion assembly 1110 through its inlet and outlet port, pump, vent, and pressure transducer. A battery may provide power to the various components, including the pump, vent, pressure transducer, processor, and user interface. The processor may be configured to implement control operations and execute algorithms for managing the cushion system's performance. The integration of these control device features with the cushion assembly 1110 may allow for more sophisticated pressure management and user comfort optimization. For example, the control device may use data from the pressure sensors 1130 to dynamically adjust the air bladders 1120 through the active valves 1150, responding to changes in user position or pressure distribution in real-time.

In some embodiments, the cushion system 1100 may interface with a user interface display 1170 that provides visual feedback and control options to users or caregivers. In some embodiments, the display 1170 may include a visual representation of the cushion assembly or a seat incorporating the cushion assembly.

In some embodiments, the display 1170 may incorporate various visual representations to convey information about the cushion system's state and pressure distribution. These representations may take different forms to suit various user preferences and application requirements. In some embodiments, the display 1170 may show a visual representation of the bladders such as with one or more bladder indicator(s) 1180, where each bladder is visually depicted in its relative position within the cushion. In some embodiments, the display 1170 may present a more abstract map of the seat area without explicitly showing individual bladders.

In some embodiments, the display may show the current pressure or inflation status of different zones within the cushion assembly 1110. This visual representation may use color coding, numerical indicators, or graphical elements to convey information about the state of the air bladders 1120. In some embodiments, the display 1170 may incorporate control elements 1190 that allow users to adjust settings, select operating modes, or initiate specific functions of the cushion system 1100. In some embodiments, these control elements 1190 may include touchscreen buttons, sliders, or other interactive elements that enable user input and system control.

### 2. Flowcharts

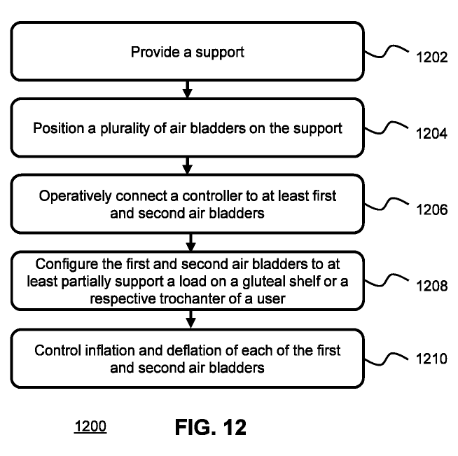

FIG. 12 illustrates a flowchart of a method 1200 for providing cushioning support. The method 1200 comprises several steps that outline the process of setting up and operating a cushion system with adjustable air bladders to provide customized support and pressure distribution.

At step 1202, the method involves providing a support. This support may serve as the foundation for the cushion system, upon which other components will be positioned. The support may include contoured portions such as a receiving portion for a left trochanter bladder and a receiving portion for a right trochanter bladder, which may create height differentials across the support surface. The support may be constructed from a supportive material such as foam that provides structural integrity to the system.

At step 1204, the method includes positioning a plurality of air bladders on the support. In some embodiments, this plurality of air bladders may comprise at least a first air bladder and a second air bladder. The air bladders may be arranged in a specific configuration to provide targeted support to different areas of the user's body. These bladders may include one or more of trochanter bladders positioned in the rear corners, IT bladders positioned between the trochanter bladders, and thigh bladders positioned in the front portion of the support. The bladders may be secured to the support using bladder attachment straps or alternative attachment mechanisms.

At step 1206, the method involves operatively connecting a controller to at least the first and second air bladders. This controller may be configured to manage the inflation and deflation of the air bladders, allowing for adjustable support and pressure distribution. The controller may include control device that processes data from pressure sensors, controls active valves, and interfaces with external systems or user interfaces. The controller may be connected to the air bladders via a control box hose, which may be routed through a bladder hose routing.

At step 1208, the method includes configuring the first and second air bladders to at load tissue that supports one or more bony prominences of a user when the user is seated on the support and when the first and second air bladders are at least partially inflated. In some cases, the first and second air bladders may be configured to at least partially support one or more of the bony prominences involved in sitting, including for example one or more trochanters or ischial tuberosities. In some cases, the first air bladder may be configured to load tissue that supports a first trochanter of the user, while the second air bladder may be configured to load tissue that supports a second trochanter of the user. This configuration may help redistribute pressure away from sensitive areas such as the tuberosity of ischium and towards regions that can better tolerate pressure, such as the areas supported by the ilium or the muscular regions around the greater trochanter.

In some cases, one or more of the plurality of air bladders comprises at least one concave portion or surface. The concave portion or surface may allow the bladder to better receive a convex portion of the user's body, creating a complementary interface that enhances contact and support. This concave configuration may conform to the natural curves and contours of the user's anatomy, such as the rounded surfaces of the hips, thighs, or other body regions. By providing a recessed area that matches the convex shape of the user's body, the concave portion may increase the surface area of contact between the bladder and the user, which may help distribute pressure more evenly across a larger area. In some embodiments, the concave portion may be designed to cradle specific anatomical features, allowing the bladder to wrap around or partially enclose convex body parts. This cradling effect may provide enhanced stability and support by creating a more secure interface between the user and the cushion system. The concave shape may also help prevent the user from sliding or shifting position during use, as the recessed area may provide a natural seating position that encourages proper alignment. By using non-symmetrical shapes and other features described herein, the bladders and cushion overall may load tissue in a more supportive, distributed way.

At step 1210, the method involves controlling, by the controller, inflation and deflation of each of the first and second air bladders. This control may allow for dynamic adjustment of the cushion system based on user needs or changes in seating position. The control may be implemented through passive valves and/or actively controlled valves, with the controller potentially using data from pressure sensors to dynamically adjust the air bladders, responding to changes in user position or pressure distribution in real-time.

In some embodiments, the first air bladder and the second air bladder may each comprise a non-symmetrical shape. This non-symmetrical shape may allow for more targeted support of specific anatomical features. The trochanter bladders may have a greater length than the other bladders and may include a curved surface for receiving or abutting a portion of a respective IT bladder.

In some embodiments, the cushion system may include a third air bladder with a shape different from the first and second air bladders. At least a portion of this third air bladder may be located at least partially between the first and second air bladders. When each of the plurality of air bladders is inflated to a common pressure, at least one of the plurality of air bladders may extend vertically higher than the third air bladder. This height differential is created by the contoured surfaces of the support, with the central portion being lower than the contoured surfaces at the corners where the trochanter bladders may be positioned.

In some embodiments, the first shape of the first air bladder may mirror the second shape of the second air bladder. Additionally, when inflated to a common pressure, the first and second air bladders may have a common volume and mirror each other in shape. The cushion system may be designed so that when the first and second air bladders are at least partially inflated, they are configured to redistribute pressure away from the user's ischial tuberosities. This pressure redistribution may help reduce the risk of discomfort or injury during prolonged sitting. The trochanter bladders may be designed to cup around the pelvis, primarily supporting the load on the greater trochanter, which allows for increased loading in these areas as they may be at lower risk of pressure injuries compared to other regions.

In some embodiments, the cushion system may include a fourth air bladder adjacent to the third air bladder. At least a portion of this fourth air bladder may be located at least partially between the first and second air bladders, and the third and fourth air bladders may have a common shape. The IT bladders may be positioned between the trochanter bladders and may have a common shape that is different from the trochanter bladders.

In some embodiments, at least two of the plurality of air bladders, when at least partially inflated, are configured to form a more continuous surface relative to a non-inflated state of the at least two bladders. The bladders may work together when inflated to create this more continuous surface, which may provide increased surface area for the user's body to contact. This increased contact area may help distribute pressure more evenly across the user's anatomy and may reduce the formation of pressure points that could occur with discrete, separated bladder surfaces. In some aspects, when the bladders inflate, they may move towards each other, reducing gaps or spaces that may exist between them in their deflated state. This movement may create a more unified support surface that conforms more closely to the user's body contours. In some embodiments, the bladders may overlap when inflated, with one bladder extending at least partially over top of another bladder. This overlapping configuration may help eliminate discontinuities in the support surface and may provide smoother transitions between different support zones. The formation of a more continuous surface through bladder interaction may be particularly beneficial in areas where multiple bladders are positioned adjacent to each other, such as between the trochanter bladders and IT bladders, or between the thigh bladders and the rear bladder array. When these bladders inflate and work together to form a more continuous surface, they may provide enhanced comfort and support by creating a more seamless seating experience for the user.

By using this method, a cushion system may be provided that provides customizable support and pressure distribution, enhancing comfort and reducing the risk of pressure-related issues for users who spend extended periods in a seated position. The system may incorporate additional features such as a pelvic ridge, lateral thigh supports, and a medial thigh support, which further enhance the system's ability to maintain proper positioning and provide targeted support.

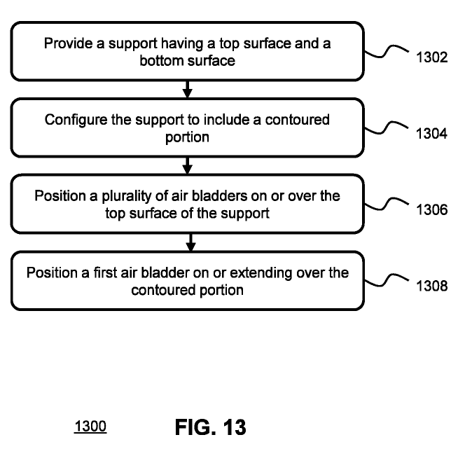

FIG. 13 illustrates a flowchart of a method 1300 for providing a cushion system. The method 1300 comprises several steps that outline the process of creating a cushion system with a contoured support and strategically positioned air bladders.

At step 1302, the method involves providing a support having a top surface and a bottom surface. This support may serve as the foundation for the cushion system and may be constructed from materials such as foam or other supportive substances that provide structural integrity to the system. The support may include various features designed to enhance comfort and pressure distribution.

At step 1304, the method includes configuring the support to include a contoured portion such that the support has a first region having a first height and a second region having a second height, wherein the first height is different from the second height. This contoured design may allow for more targeted support of specific anatomical features. In some embodiments, the first height may be at least 0.5 inches greater than the second height, creating a significant differential that can influence pressure distribution and support characteristics.

At step 1306, the method involves positioning a plurality of air bladders on or above the top surface of the support. These air bladders may be arranged in a specific configuration to provide customized support to different areas of the user's body. The plurality of air bladders may include bladders of various shapes and sizes, designed to target specific anatomical regions.

At step 1308, the method includes positioning a first air bladder of the plurality of air bladders at least partially on the contoured portion of the support. This strategic placement may allow the first air bladder to provide enhanced support to specific areas of the user's body. In some embodiments, the first air bladder may be configured to load tissue that supports a user's trochanter when the user is seated on the support.

In some embodiments, the air bladders may be positioned directly above or over top of the contoured portions of the support. This configuration may allow the bladders to initially float or suspend above the contoured surfaces when unloaded. When a user sits on the cushion, the weight and pressure may cause the bladders to bend or deform downward, eventually making contact with the contoured portions of the support beneath them. The initial suspension of the bladders above the contoured surfaces may allow for greater initial compliance and softness when the user first sits down. As the user's weight is applied, the bladders may gradually conform to both the user's body shape and the underlying contoured support surface. This progressive engagement may help to distribute pressure more evenly and reduce the likelihood of pressure points forming. The interaction between the bladders and the contoured support surfaces may provide a dynamic support system that adapts to the user's specific body contours and weight distribution.

In some aspects of the method, the contoured portion may be a first contoured portion, and the support may include a second contoured portion. A second air bladder of the plurality of air bladders may be at least partially positioned on this second contoured portion. The first air bladder may be configured to load tissue that supports a first trochanter of a user, while the second air bladder may be configured to load tissue that supports a second trochanter of the user when the user is seated on the support.

The method may further include positioning a third air bladder of the plurality of air bladders on a central region located at least partially between the first and second contoured portions. In some embodiments, at least a portion of tone of the plurality of air bladders may extend vertically higher than at least a portion of the third air bladder when inflated to a common pressure, due to their positioning on the contoured portions of the support.

In some embodiments, the support may comprise a first lateral pelvic support region and a second lateral pelvic support region angled towards a central region of the support. These angled regions may help to cradle the user's pelvis and provide additional stability. The support may also include a pelvic ridge located between a front end and a rear end of the support, which may help maintain proper pelvic positioning.

The method may include using heat to form at least one of the plurality of air bladders to have a non-uniform thickness across a cross-section of the at least one air bladder. This non-uniform thickness may allow for variable support characteristics within a single bladder.

In some embodiments, the cushion system created by this method may include additional components such as a battery for providing power to the cushion system. The system may also incorporate an air pump configured to provide sequential inflation or deflation of one or more of the plurality of air bladders, or to maintain a low interface pressure throughout at least a portion of the cushion system. In some embodiments, an alternating pressure cushion may cushion may be formed.

By using this method, a cushion system may be provided that provides customized support and pressure distribution, enhancing comfort and reducing the risk of pressure-related issues for users who spend extended periods in a seated position. The contoured support and strategically positioned air bladders may work together to create a seating surface that adapts to the user's unique anatomical features and support needs.

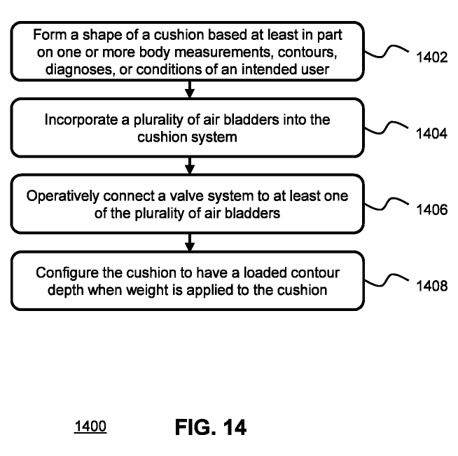

FIG. 14 illustrates a flowchart of a method 1400 for manufacturing a cushion system. The method 1400 comprises several steps that outline the process of creating a customized cushion system with specific features and capabilities.

At step 1402, the method involves forming a shape of a cushion based at least in part on one or more body measurements, contours, diagnoses, or conditions of an intended user. This step may include obtaining body measurements or contours from a mold of the intended user's body or from a digital scan of the user or a mold of the user. In some cases, the shape formation may be based on information relating to a diagnosis or condition of the intended user, such as a previous or current pressure ulcer, absent or impaired sensation in the seating area, an inability to carry out functional weight shifts, or postural asymmetries. The shape formation process may utilize computer-aided design (CAD) software, computer-aided manufacturing (CAM) technology, or three-dimensional (3D) printing technology to create a customized cushion shape.

In some embodiments, the body measurements, contours, diagnoses, or conditions used to form the shape of the cushion may be determined either directly or indirectly. In some embodiments, this may involve taking measurements or scans of the intended user in person. In some embodiments, this may involve receiving information about the intended user from another source or party, such as an Assistive Technology Professional (ATP), healthcare provider, or caregiver. For example, an ATP may provide a description of an intended user's body measurements, anatomical contours, or relevant medical diagnoses/conditions. This information may be used to form the cushion shape without the need for direct interaction with the intended user. The ATP may relay specific measurements, such as hip width or thigh length, or may describe postural asymmetries or pressure-sensitive areas that need to be accommodated in the cushion design.

In some embodiments, the cushion may be formed based on generalized information about a user's condition or diagnosis, rather than specific measurements. For instance, knowledge of a user's mobility limitations, history of pressure injuries, or specific anatomical considerations may inform the cushion shape and features without requiring precise body measurements.

This flexibility in obtaining user information may allow for customization of the cushion system even when direct access to the intended user is limited or impractical. It may also facilitate the creation of cushions tailored to address specific medical conditions or diagnoses, leveraging the expertise of healthcare professionals in the design process.

At step 1404, the method includes incorporating a plurality of air bladders into the cushion system. The plurality of air bladders may include at least a first bladder and a second bladder. In some embodiments, each of the air bladders may have a cell height of at least 50 mm. The incorporation of these bladders may involve positioning them strategically within the cushion to provide targeted support and pressure distribution.

At step 1406, the method involves operatively connecting a valve system to at least one of the plurality of air bladders. The valve system may be configured to control inflation and deflation of the air bladders, allowing for adjustable support. In some embodiments, the valve system may be designed to individually control inflation and deflation of at least one of or all of the air bladders. This step may also include operatively connecting a controller to the air bladders and the valve system, enabling automated control of inflation and deflation based on user needs or preset parameters.

At step 1408, the method includes configuring the cushion to have a loaded contour depth when weight is applied to the cushion. The loaded contour depth may be at least 25 mm, allowing for significant contouring to the user's body shape when seated. This configuration may help distribute pressure more evenly across the seating surface.

The method may include providing a cover for the cushion system that is removable and either vapor permeable or waterproof. This cover may protect the internal components while allowing for easy cleaning and maintenance. The cushion may be formed with a waterproof surface, providing an additional layer of protection against moisture and facilitating hygiene maintenance.

The method may involve configuring the cushion system to have an overload deflection of at least 5 mm when extra weight or force is applied beyond a predetermined load amount. This feature may help prevent "bottoming out" and maintain comfort even under increased loads.

The shape formation process may include forming a core from either liquid foam or a block of foam, depending on the specific requirements of the cushion design. At least one layer of the cushion may be formed from either sheets of fabric or a liquid coating material, providing additional customization options for the cushion's surface characteristics.

The method may include attaching straps to a support structure of the cushion system and using these straps to secure one or more of the air bladders in place within the cushion system. This may help maintain the proper positioning of the bladders during use. Additional components such as a pre-ischial ridge, lateral pelvic support, medial thigh support, or lateral thigh support may be incorporated into the cushion system to provide enhanced postural support and pressure distribution. In some embodiments, at least two of these additional components may be provided in the cushion system. For example, the cushion system may incorporate both a pre-ischial ridge and lateral pelvic supports to enhance postural stability and pressure distribution. Alternatively, the system may include a combination of medial thigh support and lateral thigh supports to provide comprehensive lower body positioning. The inclusion of multiple support components may allow for a more tailored approach to addressing individual user needs and anatomical variations. By combining different support features, the cushion system may offer enhanced functionality and adaptability across a wider range of seating scenarios and user requirements. In some embodiments, the cushion system may incorporate two lateral pelvic supports and/or two lateral thigh supports. The use of bilateral support structures may provide enhanced stability and pressure distribution for the user.

By using this method, a highly customized cushion system may be manufactured that addresses the specific needs and anatomical characteristics of the intended user, improving comfort, support, and pressure distribution for individuals who require specialized seating solutions.

### 3. Computer System

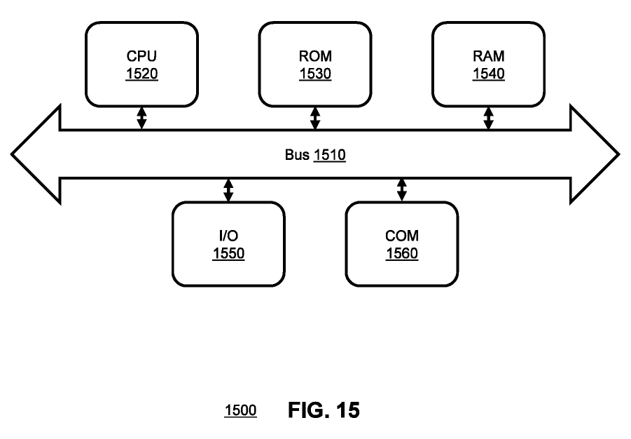

FIG. 15 depicts an example system that may execute techniques presented herein. FIG. 15 is a simplified functional block diagram of a computer that may be configured to execute techniques described herein, according to exemplary cases of the present disclosure. Specifically, the computer (or “platform” as it may not be a single physical computer infrastructure) may include a data communication interface 1560 for packet data communication. The platform may also include a central processing unit 1520 (“CPU 1520”), in the form of one or more processors, for executing program instructions. The platform may include an internal communication bus 1510, and the platform may also include a program storage and/or a data storage for various data files to be processed and/or communicated by the platform such as ROM 1530 and RAM 1540, although the system 1500 may receive programming and data via network communications. The system 1500 also may include input and output ports 1550 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### 4. Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “substantially,” “generally,” and “approximately” are used to indicate a possible variation of ±10% in a stated value.

The term “exemplary” is used in the sense of “example” rather than “ideal.”

### 5. Examples

Exemplary embodiments of the systems and methods disclosed herein are described in the numbered paragraphs below.
Example 1 is a cushion system comprising a support having a top surface and a bottom surface, wherein the support includes a contoured portion such that the support has a first region having a first height and a second region having a second height, wherein the first height is different from the second height. The cushion system further comprises a plurality of air bladders positioned on the top surface of the support, wherein a first air bladder of the plurality of air bladders is at least partially positioned on the contoured portion of the support.
In Example 2, the first air bladder of Example 1 is configured to load tissue that supports the greater trochanter when the user is seated on the support.
In Example 3, the contoured portion of Example 1 is a first contoured portion, and the support includes a second contoured portion, and a second air bladder of the plurality of air bladders is at least partially positioned on the second contoured portion.
In Example 4, the first air bladder of Example 3 is configured to load tissue that supports a first trochanter of a user and the second air bladder is configured to load tissue that supports a second trochanter of the user when the user is seated on the support.
In Example 5, the cushion system of Example 4 further comprises a third air bladder of the plurality of air bladders positioned on a central region located at least partially between the first and second contoured portions, wherein at least a portion of one of the plurality of air bladders extends vertically higher than at least a portion of the third air bladder when inflated to a common pressure.
In Example 6, the support of Example 1 comprises a first lateral pelvic support region and a second lateral pelvic support region angled towards a central region of the support.
In Example 7, the support of Example 1 further comprises a pelvic ridge located between a front end and a rear end of the support.
In Example 8, at least one of the plurality of air bladders of Example 1 has a non-uniform thickness across a cross-section of the at least one air bladder.
In Example 9, the first height of Example 1 is at least 0.5 inches greater than the second height.
In Example 10, the cushion system of Example 1 further comprises a battery for providing power to the cushion system.
In Example 11, the cushion system of Example 1 further comprises an air pump, wherein the air pump is configured to provide at least one of sequential inflation or deflation of one or more of the plurality of air bladders, or a low interface pressure throughout at least a portion of the cushion system.
Example 12 is a method of providing a cushion system, the method comprising providing a support having a top surface and a bottom surface, wherein the support includes a contoured portion such that the support has a first region having a first height and a second region having a second height, wherein the first height is different from the second height. The method further comprises positioning a plurality of air bladders on or above the top surface of the support, wherein a first air bladder of the plurality of air bladders is at least partially positioned on the contoured portion of the support.
In Example 13, the first air bladder of Example 12 is configured to load tissue that supports the greater trochanter when the user is seated on the support.
In Example 14, the contoured portion of Example 12 is a first contoured portion, and the support includes a second contoured portion, and a second air bladder of the plurality of air bladders is at least partially positioned on the second contoured portion.
In Example 15, the first air bladder of Example 14 is configured to load tissue that supports a first trochanter of a user and the second air bladder is configured to load tissue that supports a second trochanter of the user when the user is seated on the support.
In Example 16, the method of Example 15 further comprises positioning a third air bladder of the plurality of air bladders on a central region located at least partially between the first and second contoured portions, wherein at least a portion of one of the plurality of air bladders extends vertically higher than at least a portion of the third air bladder when inflated to a common pressure.
In Example 17, the support of Example 12 comprises a first lateral pelvic support region and a second lateral pelvic support region angled towards a central region of the support.
In Example 18, the support of Example 12 further comprises a pelvic ridge located between a front end and a rear end of the support.
In Example 19, the method of Example 12 further comprises using heat to form at least one of the plurality of air bladders to have a non-uniform thickness across a cross-section of the at least one air bladder.
Example 20 is a cushion system comprising a support comprising a first contoured region, a second contoured region, and a central region located between the first and second contoured regions. A thickness of the support at the central region is less than a thickness of the support at the first contoured region, and the thickness of the support at the central region is less than a thickness of the support at the second contoured region. The cushion system further comprises a plurality of air bladders positioned above the support, wherein a first air bladder of the plurality of air bladders extends over the first contoured region and a second of the plurality of air bladders extends over the second contoured region.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A cushion system comprising:
a support having a top surface and a bottom surface, wherein the support includes a contoured portion such that the support has a first region having a first height and a second region having a second height, wherein the first height is different from the second height; and
a plurality of air bladders positioned on the top surface of the support;
wherein a first air bladder of the plurality of air bladders is at least partially positioned on the contoured portion of the support.

2. The cushion system of claim 1, wherein the first air bladder is configured to load tissue that supports the greater trochanter when the user is seated on the support.

3. The cushion system of claim 1, wherein the contoured portion is a first contoured portion, and wherein the support includes a second contoured portion, and wherein a second air bladder of the plurality of air bladders is at least partially positioned on the second contoured portion.

4. The cushion system of claim 3, wherein the first air bladder is configured to load tissue that supports a first trochanter of a user and the second air bladder is configured to load tissue that supports a second trochanter of the user when the user is seated on the support.

5. The cushion system of claim 4, further comprising a third air bladder of the plurality of air bladders positioned on a central region located at least partially between the first and second contoured portions, wherein at least a portion of one of the plurality of air bladders extends vertically higher than at least a portion of the third air bladder when inflated to a common pressure.

6. The cushion system of claim 1, wherein the support comprises a first lateral pelvic support region and a second lateral pelvic support region angled towards a central region of the support.

7. The cushion system of claim 1, wherein the support further comprises a pelvic ridge located between a front end and a rear end of the support.

8. The cushion system of claim 1, wherein at least one of the plurality of air bladders has a non-uniform thickness across a cross-section of the at least one air bladder.

9. The cushion system of claim 1, wherein the first height is at least 0.5 inches greater than the second height.

10. The cushion system of claim 1, further comprising a battery for providing power to the cushion system.

11. The cushion system of claim 1, further comprising an air pump, wherein the air pump is configured to provide at least one of:
sequential inflation or deflation of one or more of the plurality of air bladders; or
a low interface pressure throughout at least a portion of the cushion system.

12. A method of providing a cushion system, the method comprising:
providing a support having a top surface and a bottom surface, wherein the support includes a contoured portion such that the support has a first region having a first height and a second region having a second height, wherein the first height is different from the second height; and
positioning a plurality of air bladders on or above the top surface of the support;
wherein a first air bladder of the plurality of air bladders is at least partially positioned on the contoured portion of the support.

13. The method of claim 12, wherein the first air bladder is configured to load tissue that supports the greater trochanter when the user is seated on the support.

14. The method of claim 12, wherein the contoured portion is a first contoured portion, and wherein the support includes a second contoured portion, and wherein a second air bladder of the plurality of air bladders is at least partially positioned on the second contoured portion.

15. The method of claim 14, wherein the first air bladder is configured to load tissue that supports a first trochanter of a user and the second air bladder is configured to load tissue that supports a second trochanter of the user when the user is seated on the support.

16. The method of claim 15, further comprising positioning a third air bladder of the plurality of air bladders on a central region located at least partially between the first and second contoured portions, wherein at least a portion of one of the plurality of air bladders extends vertically higher than at least a portion of the third air bladder when inflated to a common pressure.

17. The method of claim 12, wherein the support comprises a first lateral pelvic support region and a second lateral pelvic support region angled towards a central region of the support.

18. The method of claim 12, wherein the support further comprises a pelvic ridge located between a front end and a rear end of the support.

19. The method of claim 12, further comprising using heat to form at least one of the plurality of air bladders to have a non-uniform thickness across a cross-section of the at least one air bladder.

20. A cushion system comprising:
a support comprising:
a first contoured region;
a second contoured region; and
a central region located between the first and second contoured regions, wherein:
a thickness of the support at the central region is less than a thickness of the support at the first contoured region; and
the thickness of the support at the central region is less than a thickness of the support at the second contoured region; and
a plurality of air bladders positioned above the support;
wherein a first air bladder of the plurality of air bladders extends over the first contoured region and a second of the plurality of air bladders is extends over the second contoured region.
